(19) United States
(12) Patent Application Publication
(10) Pub. No.: US 2025/0164308 A1
(43) Pub. Date: May 22, 2025

(54) SYSTEMS AND METHODS FOR DISTRIBUTED FIBER OPTIC SENSING OVER LIVE FIBERS

(71) Applicant: Verizon Patent and Licensing Inc., Basking Ridge, NJ (US)

(72) Inventors: Jun Shan WEY, Sammamish, WA (US); Denis A. KHOTIMSKY, Westborough, MA (US); Tiejun J. XIA, Richardson, TX (US); Gregory K. SHERRILL, Herndon, VA (US)

(73) Assignee: Verizon Patent and Licensing Inc., Basking Ridge, NJ (US)

(21) Appl. No.: 18/514,942

(22) Filed: Nov. 20, 2023

(51) Int. Cl. G01H 9/00; G01D 5/353

(52) U.S. Cl. CPC G01H 9/004; G01D 5/35358

(57) ABSTRACT

A device may provide a first optical signal to an optical fiber network via a live fiber cable, the first optical signal including a distributed fiber optic sensing optical signal, and may receive, from the optical fiber network, a second optical signal, based on the first optical signal and via the live fiber cable. The device may determine whether a vibration event associated with the live fiber cable is detected based on the second optical signal, and may perform one or more actions based on whether the vibration event associated with the live fiber cable is detected.

### BACKGROUND

Distributed fiber optic sensing (DFOS) has recently been introduced into the telecommunications industry. DFOS allows optical fiber to support new services, such as determination of cable locations, cable cut prevention, perimeter intrusion detection, and other sensing-based services.

### BRIEF DESCRIPTION OF THE DRAWINGS

FIGS. 1A-1I are diagrams of an example associated with distributed fiber optic sensing over live fibers.

FIG. 2 is a diagram of an example environment in which systems and/or methods described herein may be implemented.

FIG. 3 is a diagram of example components of one or more devices of FIG. 2.

FIG. 4 is a flowchart of an example process for distributed fiber optic sensing over live fibers.

### DETAILED DESCRIPTION OF EXAMPLE EMBODIMENTS

The following detailed description of example implementations refers to the accompanying drawings. The same reference numbers in different drawings may identify the same or similar elements.

By leveraging a relative phase shift of a reflectance of Rayleigh, Brillouin, and Raman scattering of a light wave, an ambient environmental vibration, acoustic effects, temperature, and fiber/cable strain can be detected with DFOS. Current techniques utilize a DFOS system with dark fiber strands (e.g., not utilized for live data traffic) enclosed within a multistrand cable. However, dark fiber strands may not be always available in fiber routes, or reservation of the dark strands may impact efficiency of fiber deployments. Thus, current techniques for monitoring fiber network cables consume computing resources (e.g., processing resources, memory resources, communication resources, and/or the like), networking resources, and/or other resources associated with failing to provide DFOS for fibers without dark fiber strands, failing to provide DFOS for fibers that carry live data traffic, failing to support new services, such as determination of cable locations, cable cut prevention, perimeter intrusion detection, and/or other sensing-based services for fibers without dark fiber strands, and/or the like.

Some implementations described herein relate to distributed fiber optic sensing over live fibers. For example, a sensor device (e.g., a DFOS device) may provide a first optical signal to an optical fiber network via a live fiber cable, and may receive, from the optical fiber network, a second optical signal, based on the first optical signal and via the live fiber cable. The sensor device may determine whether the live fiber cable has detected a vibration event based on the second optical signal, and may perform one or more actions based on whether a vibration event has been detected. The one or more actions may include identifying a location of the detected vibration event associated with the live fiber cable and providing an alert associated with the location of the vibration event; identifying detected vibration event associated with the live fiber cable and providing an alert identifying the vibration event; and/or the like.

In this way, the sensor device provides distributed fiber optic sensing over live fibers. For example, the sensor device may utilize fiber strands that carry live data traffic for DFOS purposes without affecting a data communication service by employing a multiplexing methodology, such as wavelength-division multiplexing (WDM), to carry DFOS optical signals along with other optical signals carrying live data traffic over the same fiber strand. A sensing “channel” utilized by the sensor device may be isolated from data channels to avoid any interference of the sensing channel with the data channels. The sensing channel may be added between data channels (e.g., in-band) or out of an optical band for the data channels (e.g., out-of-band). The sensor device may be utilized with optical communication systems using distinct fiber strands for transmission in each direction of the fiber, or may be utilized with optical communication systems that use a single fiber strand for bidirectional transmission through duplexing methodologies (e.g., wavelength-division duplexing). Thus, the sensor device may conserve computing resources, networking resources, and/or other resources that would have otherwise been consumed by failing to provide DFOS for fibers without dark fiber strands, failing to provide DFOS for fibers that carry live data traffic, failing to support new services, such as determination of cable locations, cable cut prevention, perimeter intrusion detection, and/or other sensing-based services for fibers without dark fiber strands, and/or the like.

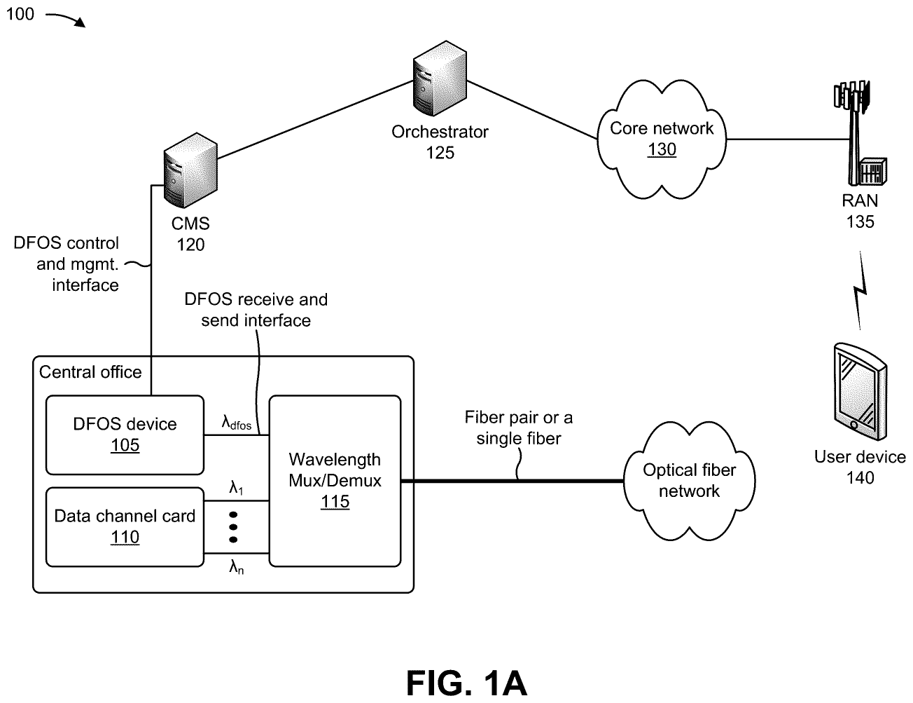

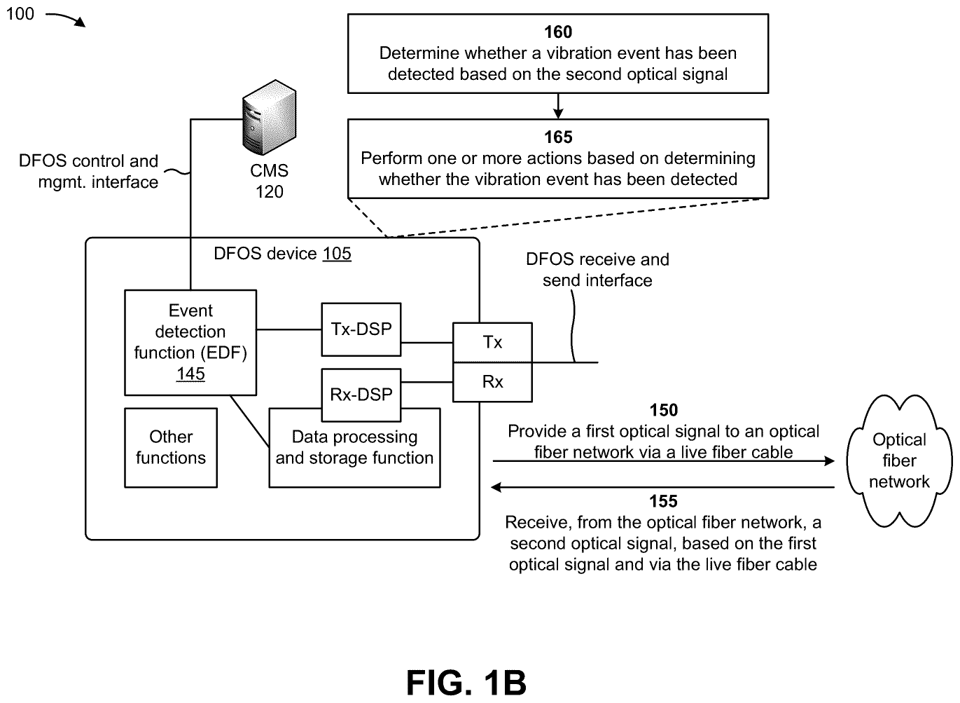

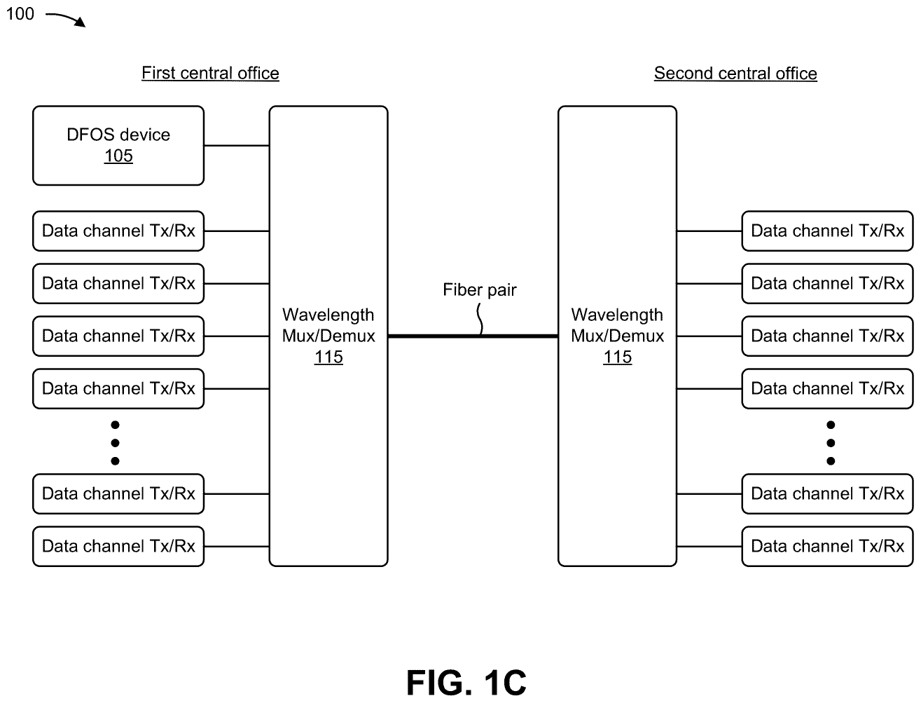

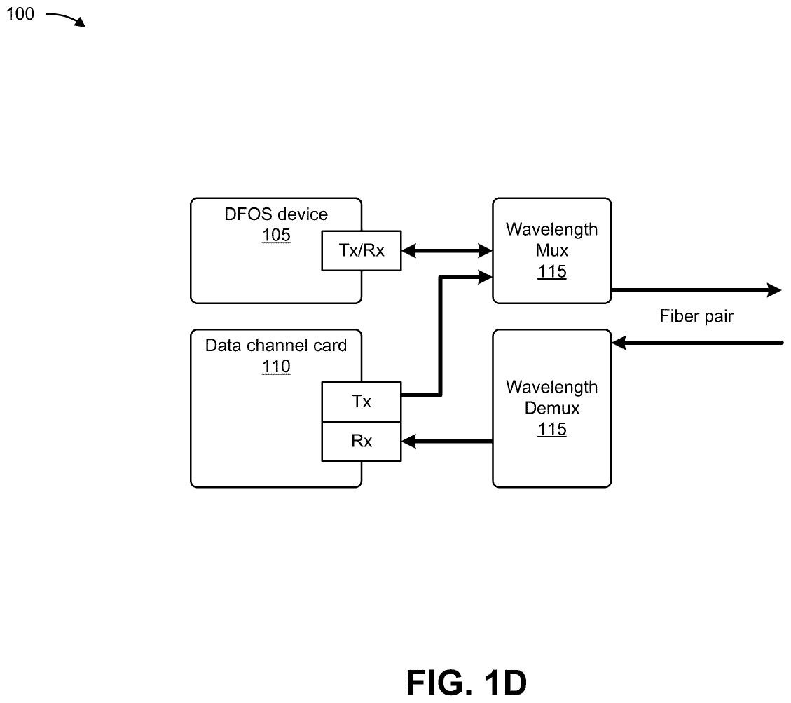

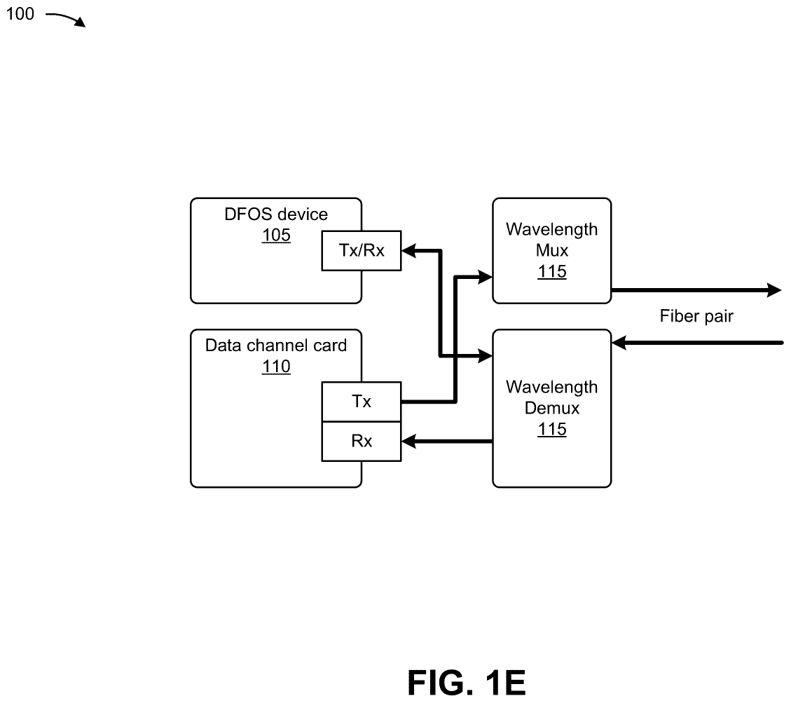

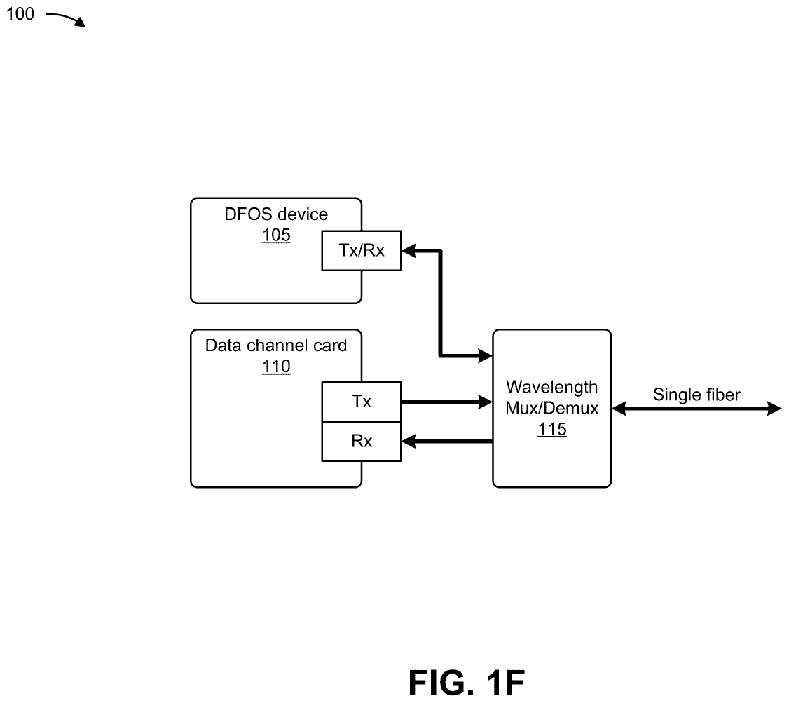

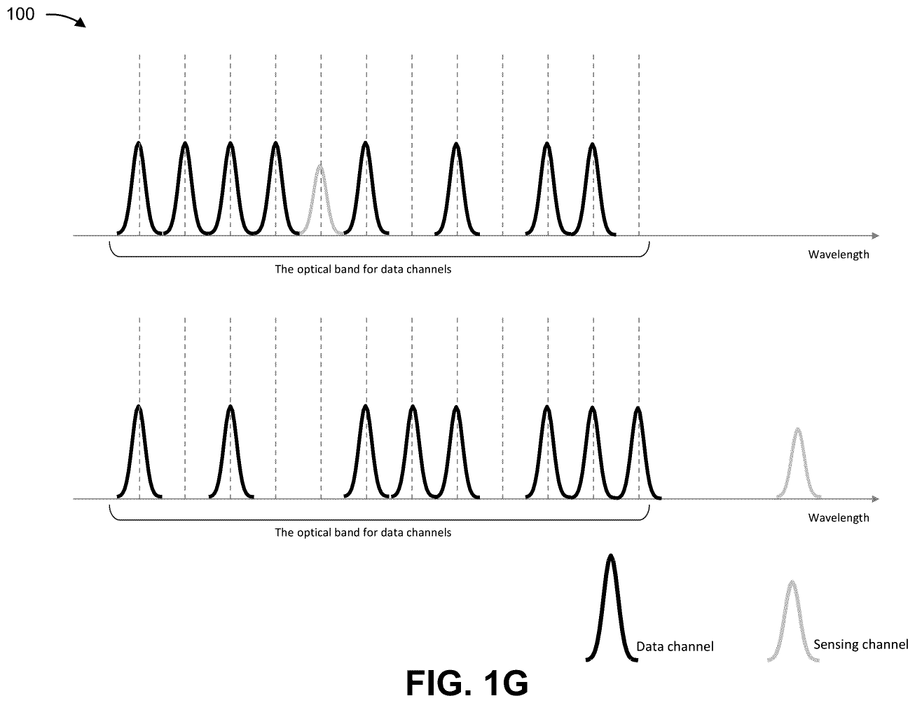

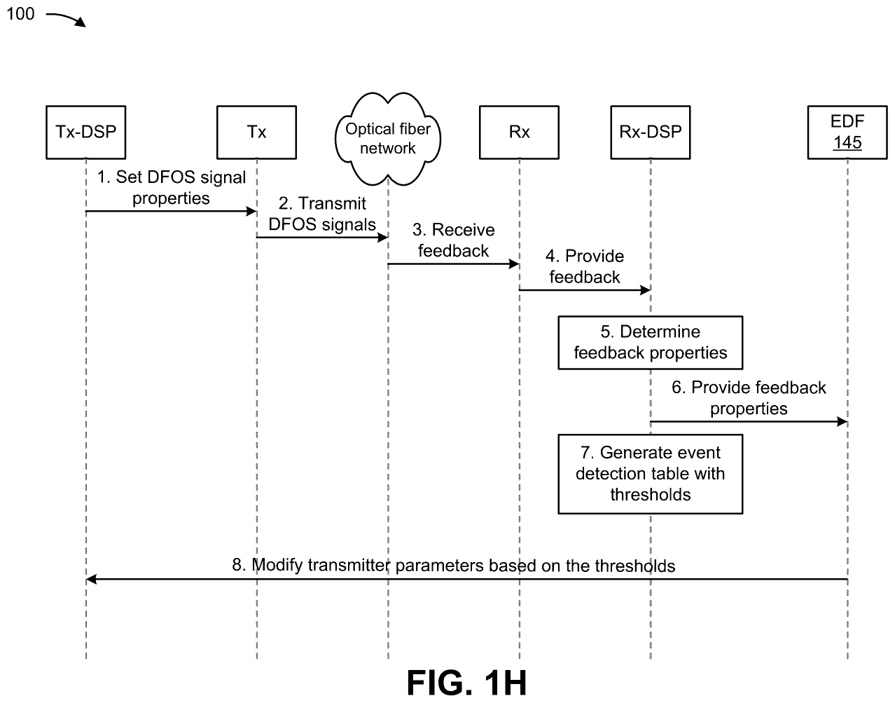

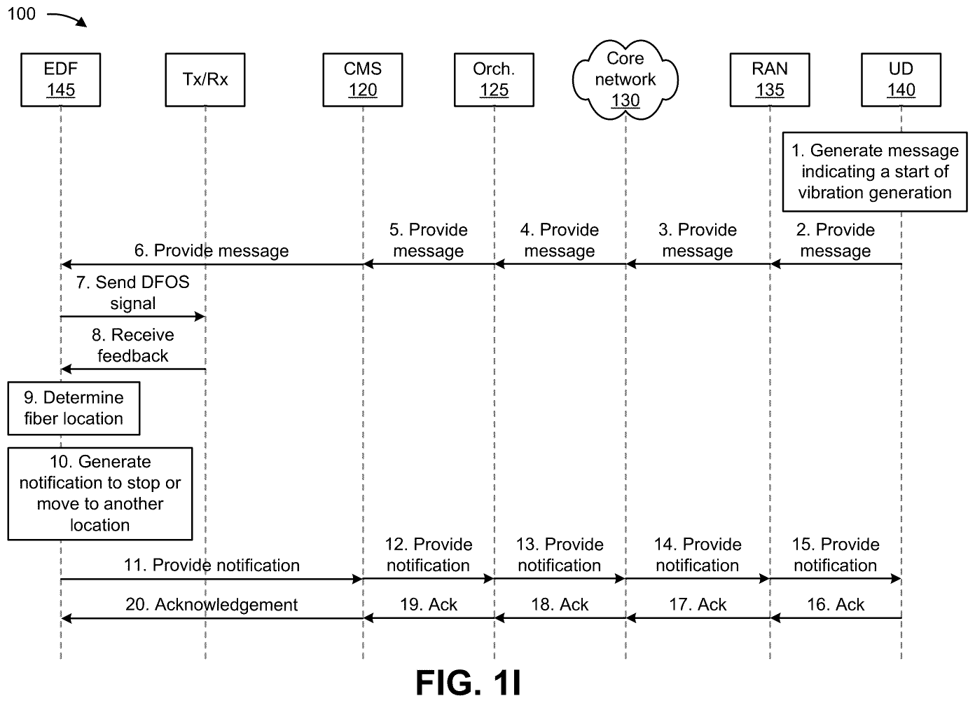

FIGS. 1A-1I are diagrams of an example 100 associated with distributed fiber optic sensing over live fibers. As shown in FIGS. 1A-1I, example 100 includes a central office with a DFOS device 105, a data channel card 110, and a wavelength multiplexer/demultiplexer 115. The central office may be associated with an optical fiber network, a control and management system (CMS) 120, an orchestrator 125, a core network 130, a radio access network (RAN) 135, and a user device 140. Further details of the central office, the DFOS device 105, the data channel card 110, the wavelength multiplexer/demultiplexer 115, the optical fiber network, the CMS 120, the orchestrator 125, the core network 130, the RAN 135, and the user device 140 are provided elsewhere herein.

As shown in FIG. 1A, the DFOS device 105 may connect to the wavelength multiplexer/demultiplexer 115 via an interface to send or receive a signal, and may connect to the CMS 120 via a control and management interface. The DFOS device 105 may utilize the send/receive interface to send a signal to be sent at a wavelength (λ_{dfos}) to the wavelength multiplexer/demultiplexer 115 or to receive the signal received at the same wavelength (λ_{dfos}) from the wavelength multiplexer/demultiplexer 115. The data channel card may process data traffic associated with multiple data channels to be sent using different wavelengths (λ₁, . . . , λₙ) to the wavelength multiplexer/demultiplexer 115 or to receive data traffic associated with the data channels using the different wavelengths (λ₁, . . . , λₙ) from the wavelength multiplexer/demultiplexer 115. Depending on whether the system is operated using in-band or out-of-band transmission, wavelength λ_{dfos} may be included in the wavelengths λ₁, . . . , λₙ (in-band) or may be separate from the wavelengths λ₁, . . . , λₙ (out-of-band).

The wavelength multiplexer/demultiplexer 115 may connect to the optical fiber network via a fiber pair or a single fiber. The fiber pair or the single fiber may be a fiber optic cable used to carry optical communications traffic in the form of optical signals. The fiber pair or the single fiber may be deployed in a route from an origin location (e.g., a central office, a point of presence, or an optical line terminal) to a destination location (e.g., a different central office, another point of presence, or another optical line terminal). The fiber pair or the single fiber may be deployed underground or above ground (e.g., using poles or other vertical stanchions). The fiber pair or the single fiber may have various small deviations from its deployment route (e.g., to avoid obstacles or comply with property rights), and may include sections that are spooled into “slack” to enable future repairs or improvements. The fiber pair or the single fiber may be a “live” fiber in the sense that is carries actual data traffic, for example as provided by the wavelength multiplexer/demultiplexer 115 via the multiple data channels.

The CMS 120 may include one or more server devices or cloud-based devices that control operation of the central office, the DFOS device 105, the data channel card 110, the wavelength multiplexer/demultiplexer 115, and/or the like. The orchestrator 125 may include one or more server devices or cloud-based devices that control multiple CMSs 120 and communicate with the core network 130. The core network 130 may include an example architecture of a fifth generation (5G) core network included in a 5G wireless telecommunications system. The RAN 135 may include one or more devices that support, for example, a cellular radio access technology (RAT). The user device 140 may include a mobile phone, a laptop computer, a tablet computer, and/or the like. The user device 140 may wirelessly connect with the RAN 135, and the RAN 135 may connect the user device 140 with the core network 130.

As shown in FIG. 1B, the DFOS device 105 may include an event detection function (EDF) 145 (e.g., a risk assessment function), a transmission (Tx)-digital signal processor (DSP), a receive (Rx)-DSP, a combined Tx/Rx port, a data processing and storage function, and other functions. The EDF 145 may communicate with the CMS 120 via the DFOS control and management interface. The Tx-DSP may receive sensing signals that have been digitized (e.g., and are to be transmitted) and may mathematically manipulate the signals. The Tx-DSP may perform mathematical functions, such as addition, subtraction, multiplication, and division very quickly. The Rx-DSP may receive optical signals from the optical fiber network, and may mathematically manipulate the signals. The Rx-DSP may perform mathematical functions, such as addition, subtraction, multiplication, and division very quickly. The Rx-DSP may detect different types of backscattering signals (e.g., Rayleigh, Brillouin, and/or Raman) and may determine backscattered power levels, wavelengths, time delays, phase, polarization, and/or the like for the signals. The combined Tx/Rx port may provide communication between the DFOS receive and send interface and the fiber pair or the single fiber. The other functions may include, for example, a laser pulse generator that generates an optical signal, a signal detection and processing component, an optical circulator, and/or the like. Further details of the EDF 145, the Tx-DSP, the Rx-DSP, the combined Tx/Rx port, the data processing and storage function, and the other functions are provided elsewhere herein.

As further shown in FIG. 1B, and by reference number 150, the DFOS device 105 may provide a first optical signal to the optical fiber network via the live fiber cable. For example, the DFOS device 105 may include a laser pulse generator that generates a first optical signal (e.g., a transmission signal) destined for the optical fiber network. The DFOS device 105 may provide the first optical signal to the live fiber cable.

As further shown in FIG. 1B, and by reference number 155, the DFOS device 105 may receive, from the optical fiber network, a second optical signal, based on the first optical signal and via the live fiber cable. For example, once the first optical signal reaches a location in the optical fiber network, the first optical signal may be (at least partially) reflected back to the DFOS device 105 as the second optical signal. The live fiber cable may provide the second optical signal to the DFOS device 105.

As further shown in FIG. 1B, and by reference number 160, the DFOS device 105 may determine whether a vibration event has been detected based on the second optical signal. For example, the DFOS device 105 may determine whether a vibration event associated with the live fiber cable has been detected based on the second optical signal. The DFOS device 105 may include a signal detection and processing component, such as the EDF 145, the Rx-DSP, the data processing and storage function, a distributed fiber optic sensing device (e.g., a Rayleigh scattering based distributed fiber optic acoustic sensing device), an optical reflectometry device (e.g., an optical time-domain reflectometry (OTDR) device), a computer, and/or the like. The DFOS device 105 may detect (using the signal detection and processing component) the second optical signal reflected back from the optical fiber network to the DFOS device 105, and may correlate and compare the second optical signal and the first optical signal. The DFOS device 105 may determine whether a vibration event is detected based on correlating and comparing the second optical signal and the first optical signal. For example, if the second optical signal is different compared to the first optical signal, the DFOS device 105 may determine that an event (e.g., a vibration event) has occurred with the live fiber cable.

As further shown in FIG. 1B, and by reference number 165, the DFOS device 105 may perform one or more actions based on determining whether a vibration event has been detected. For example, when performing the one or more actions, the DFOS device 105 may identify a location of the detected vibration event associated with the fiber cable and may provide an alert associated with the location of the vibration event. In another example, when performing the one or more actions, the DFOS device 105 may identify a vibration event associated with the fiber cable, and may provide an alert associated with the vibration event.

FIG. 1C depicts example components of two connected central offices (e.g., a first central office and a second central office). As shown, the first central office may include the DFOS device 105, a plurality of Tx/Rx data channels, and the wavelength multiplexer/demultiplexer 115. The plurality of Tx/Rx data channels may be provided by the data channel card 110 depicted in FIG. 1A. The second central office may include another plurality of Tx/Rx data channels and the wavelength multiplexer/demultiplexer 115. The DFOS device 105 and the plurality of Tx/Rx data channels may connect to the wavelength multiplexer/demultiplexer 115 of the first central office. The other plurality of Tx/Rx data channels may connect to the wavelength multiplexer/demultiplexer 115 of the second central office. The wavelength multiplexer/demultiplexer 115 of the first central office may connect to the wavelength multiplexer/demultiplexer 115 of the second central office via the live fiber cable (e.g., a fiber pair).

FIGS. 1D-1F show different example central office configurations, depending on whether the system is being operated using a fiber pair of separate send and receive fibers (e.g., simplex transmission) or combined send/receive over a single fiber (e.g., duplex transmission). FIG. 1D depicts an example configuration of the central office using simplex transmissions. As shown, the central office may include the DFOS device 105 and the data channel card 110. The wavelength multiplexer/demultiplexer 115 may be divided into a wavelength multiplexer 115 and a wavelength demultiplexer 115. The DFOS device 105 may include the combined Tx/Rx port and the data channel card 110 may include a Tx port and an Rx port. The wavelength multiplexer 115 may transmit signals via a first live fiber of the fiber pair, and the wavelength demultiplexer 115 may receive signals from a second live fiber of the fiber pair. The wavelength multiplexer 115 may receive signals from the combined Tx/Rx port of the DFOS device 105 to send over the first live fiber. The wavelength multiplexer 115 may receive signals from the Tx port of the data channel card 110 to send over the first live fiber. The wavelength demultiplexer may transmit signals it receives to the Rx port of the data channel card 110. Because the system is detecting reflections of the signals sent by the DFOS device 105 into the first live fiber, the wavelength multiplexer 115 is configured to provide signals received on the first live fiber to the combined Tx/Rx port of the DFOS device 105.

FIG. 1E depicts another example configuration of the central office using simplex transmissions. As shown, the central office may include the DFOS device 105, the data channel card 110, the wavelength multiplexer 115, and the wavelength demultiplexer 115. The DFOS device 105 may include the combined Tx/Rx port and the data channel card 110 may include the Tx port and then Rx port. The wavelength multiplexer 115 may transmit signals via a first fiber of the fiber pair, and the wavelength demultiplexer 115 may receive signals from a second fiber of the fiber pair. The wavelength multiplexer 115 may receive signals from the Tx port of the data channel card 110 to send over the first live fiber. The wavelength demultiplexer 115 may transmit signals to the combined Tx/Rx port of the DFOS device 105 and may transmit signals to the Rx port of the data channel card 110. Because the system is detecting reflections of the signals sent by the DFOS device 105, the wavelength demultiplexer 115 is configured to allow DFOS device 105 to provide signals from its Tx/Rx port to the demultiplexer for transmission over the second live fiber.

FIG. 1F depicts still another example configuration of the central office using duplex transmissions. As shown, the central office may include the DFOS device 105, the data channel card 110, and the wavelength multiplexer/demultiplexer 115. The DFOS device 105 may include the combined Tx/Rx port and the data channel card 110 may include the Tx port and then Rx port. The wavelength multiplexer/demultiplexer 115 may transmit signals via a single live fiber, and the wavelength demultiplexer 115 may receive signals from the single live fiber. The wavelength multiplexer/demultiplexer 115 may transmit signals to the combined Tx/Rx port of the DFOS device 105 and may receive signals from the combined Tx/Rx port of the DFOS device 105. The wavelength multiplexer/demultiplexer may receive signals from the Tx port of the data channel card 110 and may transmit signals to the Rx port of the data channel card 110.

A top portion of FIG. 1G depicts an example in-band channel arrangement for data channels and a sensing channel associated with the central office. As shown, each of the data channels and the sensing channel may be associated with different wavelengths, and the sensing channel may be provided on one of the wavelengths that is eligible for use to carry data channel traffic. A bottom portion of FIG. 1G depicts an example out-of-band channel arrangement for data channels and a sensing channel associated with the central office. As shown, each of the data channels and the sensing channel may be associated with a wavelength that is not eligible for use to carry data channel traffic. In some implementations, the selection of a wavelength channel to carry the sensing signal rather than data channel traffic can be performed by a management system, such as the CMS 120.

FIG. 1H is a signaling diagram of interactions between components of the DFOS device 105 and the optical fiber network. As shown at step 1, the Tx-DSP of the DFOS device 105 may set DFOS signal properties for DFOS signals. For example, the Tx-DSP may set signal powers, wavelengths, pulse widths, rates, and/or the like for the DFOS signals. As shown at step 2, the Tx port of the DFOS device 105 may transmit the DFOS signals to the optical fiber network. For example, the Tx-DSP may generate the DFOS signals with the DFOS signal properties, and may provide the DFOS signals to the Tx port. The Tx port may receive the DFOS signals and may transmit the DFOS signals to the optical fiber network. As shown at step 3, the Rx port of the DFOS device 105 may receive feedback signals from the optical fiber network. For example, the optical fiber network may generate the feedback signals based on the DFOS signals (e.g., reflections of the DFOS signals based on scattering), and may provide the DFOS signals to the Rx port.

As shown at step 4, the Rx port may provide the feedback signals to the Rx-DSP of the DFOS device 105. For example, once the Rx port receives the feedback signals, the Rx port may provide the feedback signals to the Rx-DSP. The Rx-DSP may receive the feedback signals from the Rx port. As shown at step 5, the Rx-DSP may determine feedback properties of the feedback signals. For example, the Rx-DSP may determine backscattered power levels, wavelengths, time delays, and/or the like associated with the feedback signals. As shown at step 6, the Rx-DSP may provide the feedback properties to the EDF 145 of the DFOS device 105. The EDF 145 may receive the feedback properties from the Rx-DSP.

As shown at step 7, the Rx-DSP may generate an event detection table with thresholds based on the feedback properties. For example, the Rx-DSP may process the feedback signals, with a machine learning model, to determine thresholds associated with the optical fiber network, and may generate the event detection table based on the determined thresholds. As shown at step 8, the EDF 145 may modify transmitter parameters of the Tx-DSP of the DFOS device 105 based on the thresholds.

FIG. 1I is a signaling diagram illustrating use of a DFOS system for performing a fiber cable identification and/or mapping procedure. A field engineer associated with the user device 140 may generate a vibration of a fiber cable at a geographic location. As shown at step 1, the field engineer may cause the user device 140 to generate a message indicating a start of the vibration generation by the field engineer. For example, the field engineer may input the message into the user device 140. In some implementations, the message may include an indication of the geographic location (e.g., geographic coordinates). As shown at step 2, the user device 140 may provide the message to the RAN 135. For example, the user device 140 may wirelessly connect to the RAN 135 and may wirelessly transmit the message to the RAN 135. The RAN 135 may receive the message from the user device 140. As shown at step 3, the RAN 135 may provide the message to the core network 130. For example, the RAN 135 may connect to the core network 130 via a backhaul network and may provide the message to the core network 130 via the backhaul network. The core network 130 may receive the message from the RAN 135.

As shown at step 4, the core network 130 may provide the message to the orchestrator 125. For example, the core network 130 may connect to the orchestrator 125 via a wired network, a wireless network, a cloud-based network, and/or the like. The core network 130 may provide the message to the orchestrator 125 via one of the wired network, the wireless network, the cloud-based network, and/or the like. The orchestrator 125 may receive the message from the core network 130. As shown at step 5, the orchestrator 125 may provide the message to the CMS 120. For example, the orchestrator 125 may connect to the CMS 120 via a wired network, a wireless network, a cloud-based network, and/or the like. The orchestrator 125 may provide the message to the CMS 120 via one of the wired network, the wireless network, the cloud-based network, and/or the like. The CMS 120 may receive the message from the orchestrator 125. As shown at step 6, the CMS 120 may provide the message to the EDF 145 of the DFOS device 105. The CMS 120 may connect to the EDF 145 via the DFOS control and management interface and may provide the message to the EDF 145 via the DFOS control and management interface. The EDF 145 may receive the message from the CMS 120.

As shown at step 7, the EDF 145 may send a DFOS signal to the optical fiber network via the combined Tx/Rx port of the DFOS device 105. For example, the EDF 145 may cause Tx-DSP of the DFOS device 105 to generate the DFOS signal and to provide the DFOS signal to the optical fiber network via the combined Tx/Rx port. The DFOS signal may be sent using a specific wavelength of a live fiber of the optical fiber network. For example, the DFOS signal may be sent over an in-band wavelength or an out-of-band wavelength supported by the live fiber, which may be multiplexed onto the live fiber along with other data being transmitted using other wavelengths. As shown at step 8, the EDF 145 may receive a feedback signal from the optical fiber network via the combined Tx/Rx port. For example, the optical fiber network may generate the feedback signal based on the DFOS signal (e.g., a reflection caused by Rayleigh, Brillouin, and/or Raman scattering). The feedback signal may be demultiplexed from the live fiber using the same wavelength as the transmitted DFOS signal and provided to the combined Tx/Rx port. The EDF 145 may receive the feedback signal from the combined Tx/Rx port.

As shown at step 9, the EDF 145 may determine an event indicating the vibration based on the feedback signal. For example, the properties of the feedback signal may provide an indication of the vibration of the fiber, and the EDF 145 may determine the location along the fiber where the vibration occurred based on the properties of the feedback signal (e.g., a time delay from the signal transmission). The EDF 145 may indicate to the CMS 120 the determined fiber location that corresponds to the vibration's geographic location, so that CMS 120 can populate a database of fiber location to geographic location mappings. As shown at step 10, the EDF 145 may generate a notification to stop the vibration and/or move to another location (e.g., to vibrate another fiber cable).

As shown at step 11, the EDF 145 may provide the notification to the CMS 120 via the DFOS control and management interface. The CMS 120 may receive the notification from the EDF 145. As shown at step 12, the CMS 120 may provide the notification to the orchestrator 125 via one of the wired network, the wireless network, the cloud-based network, and/or the like. The orchestrator 125 may receive the notification from the CMS 120. As shown at step 13, the orchestrator 125 may provide the notification to the core network 130 via one of the wired network, the wireless network, the cloud-based network, and/or the like. The core network 130 may receive the notification from the orchestrator 125. As shown at step 14, the core network 130 may provide the notification to the RAN 135 via the backhaul network. The RAN 135 may receive the notification from the core network 130. As shown at step 15, the RAN 135 may wirelessly transmit the notification to the user device 140. The user device 140 may receive the notification from the RAN 135. The field engineer may cause the user device 140 to generate an acknowledgement of the notification.

As shown at step 16, the user device 140 may wirelessly transmit the acknowledgement to the RAN 135. The RAN 135 may receive the acknowledgement from the user device 140. As shown at step 17, the RAN 135 may provide the acknowledgement to the core network 130 via the backhaul network. The core network 130 may receive the acknowledgement from the RAN 135. As shown at step 18, the core network 130 may provide the acknowledgement to the orchestrator 125 via one of the wired network, the wireless network, the cloud-based network, and/or the like. The orchestrator 125 may receive the acknowledgement from the core network 130. As shown at step 19, the orchestrator 125 may provide the acknowledgement to the CMS 120 via one of the wired network, the wireless network, the cloud-based network, and/or the like. The CMS 120 may receive the acknowledgement from the orchestrator 125. As shown at step 20, the CMS 120 may provide the acknowledgement to the EDF 145 via the DFOS control and management interface. The EDF 145 may receive the acknowledgement from the CMS 120.

In this way, the sensor device (e.g., the DFOS device 105) provides distributed fiber optic sensing over live fibers. For example, the sensor device may utilize fiber strands that carry live data traffic for DFOS purposes without affecting a data communication service by employing a modulation methodology (e.g., WDM) to carry DFOS optical signals along with other optical signal over the same fiber strand. A sensing channel utilized by the sensor device may be isolated from data channels to avoid any interference of the sensing channel with the data channels. The sensing channel may use wavelengths that can also be used for carrying data channel traffic (e.g., in-band) or may use wavelengths that are not used for carrying data channel traffic (e.g., out-of-band). The sensor device may be utilized in optical communication systems using distinct fiber strands for transmission in each direction of the fiber, or may be utilized with optical communication systems that use a single fiber strand for bidirectional (duplex) transmission. Thus, the sensor device may conserve computing resources, networking resources, and/or other resources that would have otherwise been consumed by failing to provide DFOS for fibers without dark fiber strands, failing to provide DFOS for fibers that carry live data traffic, failing to support new services, such as determination of cable locations, cable cut prevention, perimeter intrusion detection, and/or other sensing-based services for fibers without dark fiber strands, and/or the like.

In some implementations, the data processing function and the Rx-DSP of the EDF 145 may utilize a machine learning model to determine whether an event has been detected. For example, the Rx-DSP may receive feedback optical signals based on a plurality of optical signals provided to the optical fiber network, and may process the feedback optical signals, with a machine learning model, to train the model to determine thresholds associated with detecting vibration events in the optical fiber network. The Rx-DSP may generate an event detection table that includes the thresholds. The trained machine learning model may then be used to detect vibration events more accurately. The EDF 145 may modify parameters of the Tx-DSP based on the thresholds.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

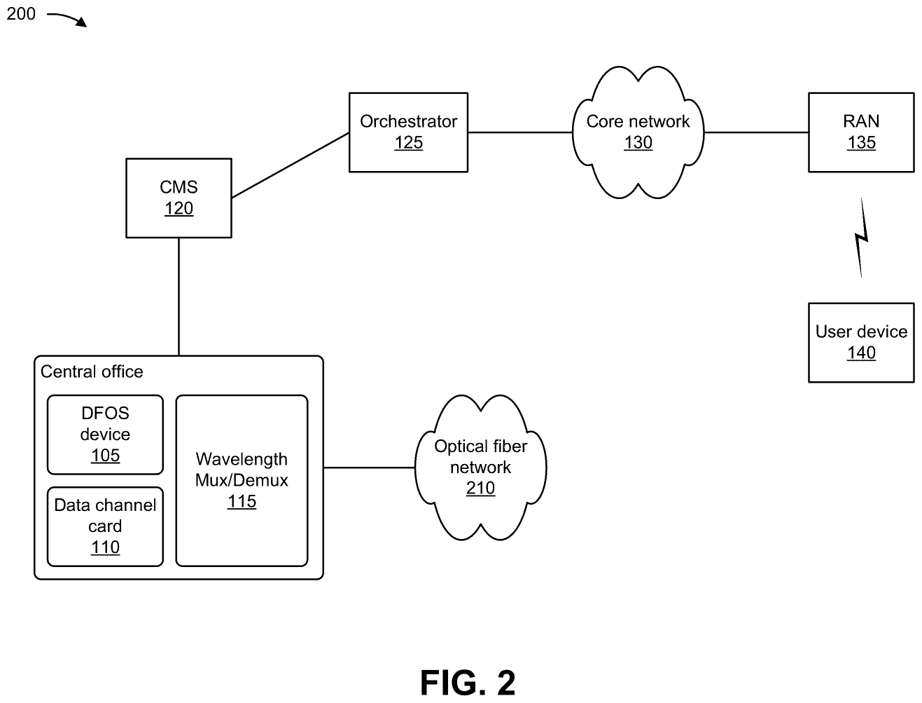

FIG. 2 is a diagram of an example environment 200 in which systems and/or methods described herein may be implemented. As shown in FIG. 2, the environment 200 may include the central office (e.g., with the DFOS device 105, the data channel card 110, and the wavelength multiplexer/demultiplexer 115), an optical fiber network 210, the CMS 120, the orchestrator 125, the core network 130, the RAN 135, and the user device 140. Devices and/or elements of the environment 200 may interconnect via wired connections and/or wireless connections.

The central office may include one or more devices capable of receiving, generating, storing, processing, and/or providing information in a manner described herein. For example, in the context of telecommunications, the central office is a device which begins or ends a telecommunications link and is a point at which a signal enters or leaves a network, such as the optical fiber network 210. In some implementations, the central office may include a network device, such as a label switching router (LSR), a label edge router (LER), an ingress router, an egress router, a provider router (e.g., a provider edge router or a provider core router), a virtual router, or another type of router. Additionally, or alternatively, the central office may include a gateway, a switch, a firewall, a hub, a bridge, a reverse proxy, a server (e.g., a proxy server, a cloud server, or a data center server), a load balancer, and/or a similar device. In some implementations, the central office may be a physical device implemented within a housing, such as a chassis. In some implementations, a group of central offices may be a group of data center nodes that are used to route traffic flow through a network.

The DFOS device 105 may include one or more devices capable of receiving, generating, storing, processing, and/or providing information, such as information described herein. For example, the DFOS device 105 may include optical components, including a distributed fiber optic sensor device-such as a distributed fiber optic acoustic sensor device that uses a fiber cable to provide distributed strain sensing, where the fiber cable is a sensing element and vibration detection and measurements are made using an optoelectronic device. The distributed fiber optic acoustic sensor device may include a Rayleigh scattering-based distributed fiber optic acoustic sensor device. The DFOS device 105 may further include an optical reflectometry device, such as an optical time-domain reflectometry (OTDR) device. The optical reflectometry device may be used with the distributed optical sensor device to perform acoustical sensing of vibrations applied to and experienced by a fiber optic cable. The DFOS device 105 may also include or be associated with a processing system, such as a laptop computer, a tablet computer, a desktop computer, a server, a handheld computer, or a similar type of device, that determines vibration events and fiber cable distances to detected vibrations.

The data channel card 110 may include a device or a component that provides multiple data channels connected to the wavelength multiplexer/demultiplexer 115. The data channel card may convert digital data into optical data signals, and may provide the optical data signals to the multiplexer/demultiplexer 115 via the multiple data channels. The data channel card may receive optical data signals from the wavelength multiplexer/demultiplexer 115, and may convert the optical data signals into digital data.

The wavelength multiplexer/demultiplexer 115 may include a device that increases bandwidth over fiber optic networks. A multiplexer portion of the wavelength multiplexer/demultiplexer 115 may combine several data signals together for transporting over a single fiber. In some implementations, the multiplexer portion may filter and combine multiple wavelengths onto a single output port for transmission through a fiber. A demultiplexer portion of the wavelength multiplexer/demultiplexer 115 may filter and separate signals received together and may provide each data channel to an optical receiver (e.g., the DFOS device 105 and/or the data channel card 110). In some implementations, the demultiplexer portion may separate combined wavelengths received from a fiber, and may provide the signals modulated onto the separated wavelengths to the DFOS device 105 in the case of the sensing channel and/or to the data channel card 110 in the case of the data channels.

The CMS 120 may include one or more devices capable of receiving, generating, storing, processing, providing, and/or routing information, as described elsewhere herein. The CMS 120 may include a communication device and/or a computing device. For example, the CMS 120 may include a server, such as an application server, a client server, a web server, a database server, a host server, a proxy server, a virtual server (e.g., executing on computing hardware), or a server in a cloud computing system. In some implementations, the CMS 120 may include computing hardware used in a cloud computing environment.

The orchestrator 125 may include one or more devices capable of receiving, generating, storing, processing, providing, and/or routing information, as described else where herein. The orchestrator 125 may include a communication device and/or a computing device. For example, the orchestrator 125 may include a server, such as an application server, a client server, a web server, a database server, a host server, a proxy server, a virtual server (e.g., executing on computing hardware), or a server in a cloud computing system. In some implementations, the orchestrator 125 may include computing hardware used in a cloud computing environment.

In some implementations, the core network 130 may include an example functional architecture in which systems and/or methods described herein may be implemented. For example, the core network 130 may include an example architecture of a fifth generation (5G) core network included in a 5G wireless telecommunications system. While the example of the core network 130 may be an example of a service-based architecture, in some implementations, the core network 130 may be implemented as a reference-point architecture and/or a fourth generation (4G) core network, among other examples. The core network 130 may include a number of functional elements. The functional elements may include, for example, a network slice selection function (NSSF), a network exposure function (NEF), an authentication server function (AUSF), a unified data management (UDM) component, a policy control function (PCF), an application function (AF), an access and mobility management function (AMF), a session management function (SMF), a user plane function (UPF), and/or the like. These functional elements may be communicatively connected via a message bus. Each of the functional elements may be implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The RAN 135 may support, for example, a cellular radio access technology (RAT). The RAN 135 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the user device 140. The RAN 135 may transfer traffic between the user device 140 (e.g., using a cellular RAT), one or more base stations (e.g., using a wireless interface or a backhaul interface, such as a wired backhaul interface), and/or the core network 130. The RAN 135 may provide one or more cells that cover geographic areas.

In some implementations, the RAN 135 may perform scheduling and/or resource management for the user device 140 covered by the RAN 135 (e.g., a user device 140 covered by a cell provided by the RAN 135). In some implementations, the RAN 135 may be controlled or coordinated by a network controller, which may perform load balancing, network-level configuration, and/or other operations. The network controller may communicate with the RAN 135 via a wireless or wireline backhaul. In some implementations, the RAN 135 may include a network controller, a self-organizing network (SON) module or component, or a similar module or component. In other words, the RAN 135 may perform network control, scheduling, and/or network management functions (e.g., for uplink, downlink, and/or sidelink communications of the user device 140 covered by the RAN 135).

The user device 140 includes one or more devices capable of receiving, generating, storing, processing, and/or providing information, such as information described herein. For example, the user device 140 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The optical fiber network 210 may include a network of cables containing bundles of glass or plastic strands called optical fibers or fiber cables, which carry data that has been transformed into light. The light may be transmitted along the optical fiber network 210 by a laser, after having been converted by a computer into digital data signals. The optical fiber network 210 may enable communication among one or devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

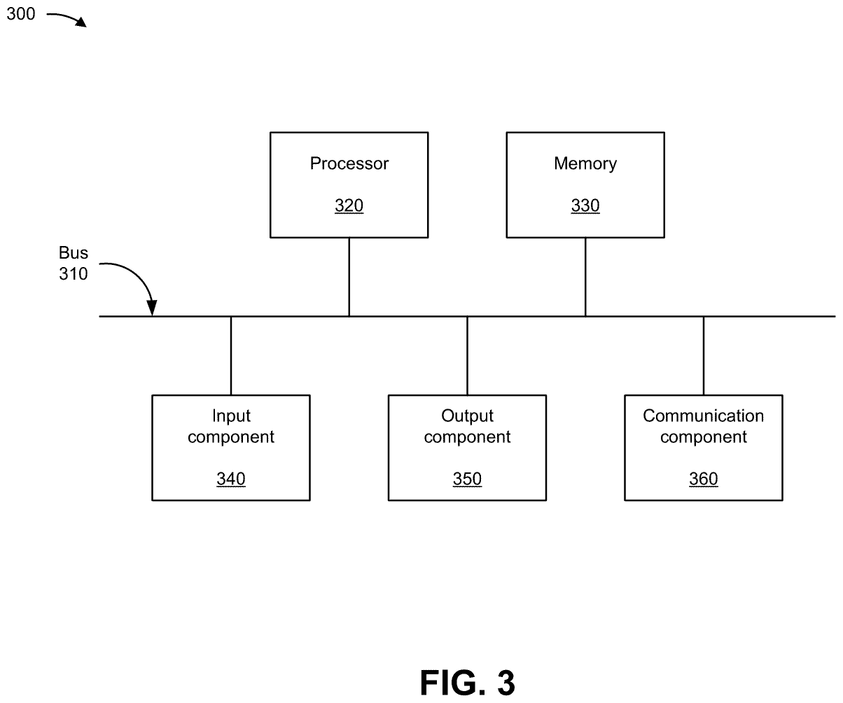

FIG. 3 is a diagram of example components of a device 300, which may correspond to the DFOS device 105, the data channel card 110, the wavelength multiplexer/demultiplexer 115, the CMS 120, the orchestrator 125, the RAN 135, and/or the user device 140. In some implementations, the DFOS device 105, the data channel card 110, the wavelength multiplexer/demultiplexer 115, the CMS 120, the orchestrator 125, the RAN 135, and/or the user device 140 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

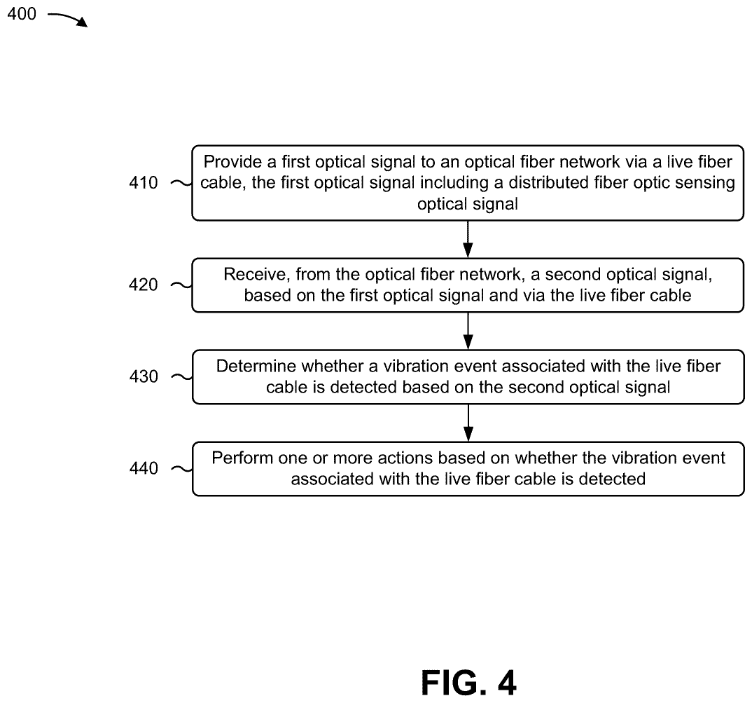

FIG. 4 depicts a flowchart of an example process 400 for distributed fiber optic sensing over live fibers. In some implementations, one or more process blocks of FIG. 4 may be performed by a device (e.g., the DFOS device 105). In some implementations, one or more process blocks of FIG. 4 may be performed by another device or a group of devices separate from or including the device, such as a CMS (e.g., the CMS 120) and/or an orchestrator (e.g., the orchestrator 125). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include providing a first optical signal to an optical fiber network via a live fiber cable, the first optical signal including a distributed fiber optic sensing optical signal (block 410). For example, the device may provide a first optical signal to an optical fiber network via a live fiber cable, as described above. In some implementations, the first optical signal includes a distributed fiber optic sensing optical signal. In some implementations, the live fiber cable includes one of a single fiber cable or a fiber cable pair. In some implementations, the device is a distributed fiber optic sensing device.

As further shown in FIG. 4, process 400 may include receiving, from the optical fiber network, a second optical signal, based on the first optical signal and via the live fiber cable (block 420). For example, the device may receive, from the optical fiber network, a second optical signal, based on the first optical signal and via the live fiber cable, as described above.

As further shown in FIG. 4, process 400 may include determining whether a vibration event associated with the live fiber cable is detected based on the second optical signal (block 430). For example, the device may determine whether a vibration event associated with the live fiber cable is detected based on the second optical signal, as described above. In some implementations, determining whether the vibration event associated with the live fiber cable is detected based on the second optical signal comprises comparing the second optical signal with an event detection table, and determining whether the vibration event associated with the live fiber cable is detected based comparing the second optical signal with the event detection table.

As further shown in FIG. 4, process 400 may include performing one or more actions based on whether the vibration event associated with the live fiber cable is detected (block 440). For example, the device may perform one or more actions based on whether the vibration event associated with the live fiber cable is detected, as described above.

In some implementations, process 400 includes selecting a wavelength for the first optical signal prior to providing the first optical signal to the optical fiber network. In some implementations, the wavelength is included in wavelengths utilized for live data traffic provided to the optical fiber network. In some implementations, the wavelength is separate from wavelengths utilized for live data traffic provided to the optical fiber network.

In some implementations, process 400 includes receiving feedback optical signals based on providing a plurality of optical signals to the optical fiber network, processing the feedback optical signals, with a machine learning model, to determine thresholds associated with the optical fiber network, and modifying transmitter parameters of the device based on the thresholds. In some implementations, determining whether the vibration event associated with the live fiber cable is detected based on the second optical signal includes comparing the second optical signal with the thresholds, and determining whether the vibration event associated with the live fiber cable is detected based comparing the second optical signal with the thresholds.

In some implementations, process 400 includes receiving, from a user device and via a wireless network, a message indicating a start of vibration generation associated with the live fiber cable; providing a third optical signal to the optical fiber network via a live fiber cable based on receiving the message; receiving, from the optical fiber network, a fourth optical signal, based on the third optical signal and via the live fiber cable; and determining a location associated with the live fiber cable based on the fourth optical signal. In some implementations, process 400 includes generating a notification indicating determination of the location associated with the live fiber cable, providing the notification to the user device and via the wireless network, and receiving, from the user device and via the wireless network, acknowledgment of the notification.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, by a device, a first optical signal to an optical fiber network via a live fiber cable, the first optical signal including a distributed fiber optic sensing optical signal;
receiving, by the device and from the optical fiber network, a second optical signal, based on the first optical signal and via the live fiber cable;
determining, by the device, whether a vibration event associated with the live fiber cable is detected based on the second optical signal; and
performing, by the device, one or more actions based on whether the vibration event associated with the live fiber cable is detected.

2. The method of claim 1, further comprising:
selecting a wavelength for the first optical signal prior to providing the first optical signal to the optical fiber network.

3. The method of claim 2, wherein the wavelength is included in wavelengths utilized for live data traffic provided to the optical fiber network.

4. The method of claim 2, wherein the wavelength is separate from wavelengths utilized for live data traffic provided to the optical fiber network.

5. The method of claim 1, wherein determining whether the vibration event associated with the live fiber cable is detected based on the second optical signal comprises:
comparing the second optical signal with an event detection table; and
determining whether the vibration event associated with the live fiber cable is detected based comparing the second optical signal with the event detection table.

6. The method of claim 1, further comprising:
receiving feedback optical signals based on providing a plurality of optical signals to the optical fiber network;
processing the feedback optical signals, with a machine learning model, to determine thresholds associated with the optical fiber network; and
modifying transmitter parameters of the device based on the thresholds.

7. The method of claim 6, wherein determining whether the vibration event associated with the live fiber cable is detected based on the second optical signal comprises:
comparing the second optical signal with the thresholds; and
determining whether the vibration event associated with the live fiber cable is detected based comparing the second optical signal with the thresholds.

8. A device, comprising:
one or more processors configured to:
provide a first optical signal to an optical fiber network via a live fiber cable, the first optical signal including a distributed fiber optic sensing optical signal;
receive, from the optical fiber network, a second optical signal, based on the first optical signal and via the live fiber cable;
determine whether a vibration event associated with the live fiber cable is detected based on the second optical signal; and
perform one or more actions based on whether the vibration event associated with the live fiber cable is detected.

9. The device of claim 8, wherein the one or more processors are further configured to:
receive, from a user device and via a wireless network, a message indicating a start of vibration generation associated with the live fiber cable;
provide a third optical signal to the optical fiber network via a live fiber cable based on receiving the message;
receive, from the optical fiber network, a fourth optical signal, based on the third optical signal and via the live fiber cable; and
determine a location associated with the live fiber cable based on the fourth optical signal.

10. The device of claim 9, wherein the one or more processors are further configured to:
generate a notification indicating determination of the location associated with the live fiber cable;
provide the notification to the user device and via the wireless network; and
receive, from the user device and via the wireless network, acknowledgment of the notification.

11. The device of claim 8, wherein a wavelength of the first optical signal is included in wavelengths utilized for live data traffic provided to the optical fiber network.

12. The device of claim 8, wherein a wavelength of the first optical signal is separate from wavelengths utilized for live data traffic provided to the optical fiber network.

13. The device of claim 8, wherein the live fiber cable includes one of a single fiber cable or a fiber cable pair.

14. The device of claim 8, wherein the device is a distributed fiber optic sensing device.

15. A non-transitory computer-readable medium storing a set of instructions, the set of instructions comprising:
one or more instructions that, when executed by one or more processors of a device, cause the device to:
provide a first optical signal to an optical fiber network via a live fiber cable, the first optical signal including a distributed fiber optic sensing optical signal;
receive, from the optical fiber network, a second optical signal, based on the first optical signal and via the live fiber cable;
determine whether a vibration event associated with the live fiber cable is detected based on the second optical signal; and
perform one or more actions based on whether the vibration event associated with the live fiber cable is detected.

16. The non-transitory computer-readable medium of claim 15, wherein the one or more instructions, that cause the device to perform the one or more actions, cause the device to one or more of:
identify a location of an issue associated with the live fiber cable and provide an alert associated with the location of the issue; or
identify an issue associated with the live fiber cable and provide an alert identifying the issue.

17. The non-transitory computer-readable medium of claim 15, wherein the one or more instructions further cause the device to:
receive feedback optical signals based on providing a plurality of optical signals to the optical fiber network;
process the feedback optical signals, with a machine learning model, to determine thresholds associated with the optical fiber network; and
modify transmitter parameters of the device based on the thresholds.

18. The non-transitory computer-readable medium of claim 15, wherein the one or more instructions further cause the device to:
receive, from a user device and via a wireless network, a message indicating a start of vibration generation associated with the live fiber cable;
provide a third optical signal to the optical fiber network via a live fiber cable based on receiving the message;
receive, from the optical fiber network, a fourth optical signal, based on the third optical signal and via the live fiber cable; and
determine a location associated with the live fiber cable based on the fourth optical signal.

19. The non-transitory computer-readable medium of claim 18, wherein the one or more instructions further cause the device to:
generate a notification indicating determination of the location associated with the live fiber cable;
provide the notification to the user device and via the wireless network; and
receive, from the user device and via the wireless network, acknowledgment of the notification.

20. The non-transitory computer-readable medium of claim 15, wherein a wavelength of the first optical signal is included in or separate from wavelengths utilized for live data traffic provided to the optical fiber network.
